(19) United States
(12) Patent Application Publication
(10) Pub. No.: US 2002/0151270 A1
(43) Pub. Date: Oct. 17, 2002

(54) Method of programming wireless broadband equipment

(76) Inventor: Ronny Johnston, Lufkin, TX (US)

Correspondence Address: RONNY JOHNSTON, VICE PRESIDENT OF NETWORK ENGINEERING, DATACENTRIC BROADBAND, 262 NORTH SAM HOUSTON PARKWAY EAST, SUITE 150, HOUSTON, TX, 77060, US

(21) Appl. No.: 09/835,433

(22) Filed: Apr. 16, 2001

(51) Int. Cl. H04H 1/00

(52) U.S. Cl. 455/3.05; 455/419; 455/426

(57) ABSTRACT

A method and apparatus for programming the operation of one or more wireless broadband equipment. The present invention first receives the data. The data is then arranged into a format readable by the one or more wireless broadband equipment. Once arranged, the data is then stored into one or more text files. In arranging the data, one or more command lines may be added to the data; and one or more line feeds may be added to the data. In accordance with another embodiment of the present invention, a method for arranging configuration data stored in a wireless broadband equipment into a new format is provided. The method begins by retrieving a copy of the configuration data from the wireless broadband equipment. The copy of the configuration data is then arranged into the new format. Once arranged, the copy of the configuration data is stored into the wireless broadband equipment. In retrieving a copy of the configuration data, an electrical connection with the wireless broadband equipment is first established. Then, a command line is sent to the wireless broadband equipment through the electrical connection requesting a copy of the configuration data from the wireless broadband equipment. A copy of the configuration data is then received from the wireless broadband equipment.

### TECHNICAL FIELD OF THE INVENTION

This invention relates generally to the field of telecommunications, and more particularly, to a method of programming wireless broadband equipment in a fixed wireless broadband network.

### BACKGROUND OF THE INVENTION

Without limiting the scope of the invention, this background of the present invention is in connection with the configuration or programming of the wireless broadband equipment or units in a fixed wireless broadband network.

Today, telecommunications operators and Internet service providers are using fixed broadband wireless access equipment to enhance or replace existing networks—wired or wireless—or to develop new networks where wire line broadband access is not available. The fixed broadband wireless technology is typically deployed in a cellular pattern to provide a complete geographic coverage. Each cell site may use a number of access points, i.e., sectors or antennae, ranging from one to fifteen access points to offer a 360-degree coverage. The number of access points depends on the subscriber demand and coverage. Each access point typically consists of an antenna and a modem. The antenna and the modem may also be integrated into one piece of equipment. Each access point establishes a high-speed channel shared among up to 255 simultaneous active subscriber units that provide a standard Ethernet or ATM interface. Cell sites are typically interconnected by either conventional wired backhaul, or by wireless point-to-point links.

In general, the subscriber units and the access points will not be operational until they are programmed or configured. However, many of the programming methods that exist today are too limited in its capability and flexibility. That is, they can only operate with a single technology configuration, e.g., classic IP (“CLIP”) technology, and not across network boundary lines and across different operational characteristics. Furthermore, current programming methods require a technician to manually program each subscriber unit and access point for each subscription. Consequently, programming these units requires a significant amount of time and money.

What is needed therefore is a method of programming these network equipment, such as subscriber units and the access points, that overcomes the limitations of current programming methods without increasing the cost and complexity of programming these equipment.

### SUMMARY OF THE INVENTION

The present invention has many advantages. As an example, the present invention provides a much broader scope of technology configurations than what the current programming methods. That is, the present invention provides the ability and flexibility to program multiple type connections, i.e., point to point, point to multi point, ATM point to point, router to router configurations between cell sites.

Additionally, the present invention reduces the amount of time it takes to program/configure each wireless broadband equipment. On average, the present invention will reduce the time to program the wireless broadband equipment by 70%. By using the present invention, a technician is no longer required to know the exact command lines necessary to program each equipment. All the technician would need to know is the raw configuration data. The present invention essentially takes the raw data and uses them to program the equipment for him.

This reduction in manual programming consequently will also reduce the number of programming error caused by the technician. The reduction in programming error will in turn lead to a reduction in the number of malfunction wireless broadband equipment due to programming error.

In addition, with the present invention, the wireless broadband equipment can be remotely programmed and managed through a communication protocol. It would no longer be necessary for a technician to go to the wireless broadband equipment location to program or diagnose it.

The present invention also provides the ability to remotely view the configuration data stored in a wireless broadband equipment. This ability also facilitates diagnosing the wireless broadband equipment without having the technical knowledge necessary to retrieve the data. Thus, one may diagnose the wireless broadband equipment without the risk of altering its configuration data.

More specifically, the present invention provides a method and apparatus for programming the operation of one or more wireless broadband equipment. The present invention first receives the data. The data is then arranged into a format readable by the one or more wireless broadband equipment. Once arranged, the data is then stored into one or more text files. In arranging the data, one or more command lines may be added to the data; and one or more line feeds may be added to the data.

In accordance with another embodiment of the present invention, a method for arranging configuration data stored in a wireless broadband equipment into a new format is provided. The method begins by retrieving a copy of the configuration data from the wireless broadband equipment. The copy of the configuration data is then arranged into the new format. Once arranged, the copy of the configuration data is stored into the wireless broadband equipment. In retrieving a copy of the configuration data, an electrical connection with the wireless broadband equipment is first established. Then, a command line is sent to the wireless broadband equipment through the electrical connection requesting a copy of the configuration data from the wireless broadband equipment. A copy of the configuration data is then received from the wireless broadband equipment.

In accordance with yet another embodiment of the present invention, a method for copying configuration data of a wireless broadband equipment from a program storage device to the wireless broadband equipment is provided. The method begins by retrieving a copy of the configuration data from the program storage device. Then, an electrical connection with the wireless broadband equipment is established. Once the connection is established, the copy of the configuration data is sent to the wireless broadband equipment through the electrical connection. Then, a command line is sent to the wireless broadband equipment through the electrical connection to reboot the wireless broadband equipment. In retrieving a copy of the configuration data, information identifying the wireless broadband equipment is received. The information includes an identifier that is associated with the wireless broadband equipment. The configuration data that is associated with the identifier is then retrieved from the program storage device.

Another embodiment of the present invention provides a method of configuring a wireless broadband equipment. The method first receives one or more configuration data. The one or more configuration data is then arranged into a format readable by the wireless broadband equipment. Once arranged, the one or more configuration data is then stored into the wireless broadband equipment.

Other features and advantages of the present invention shall be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 depicts a diagram illustrative of a prior art fixed wireless broadband network;

FIG. 2 depicts a block diagram illustrative of a method of formatting data for configuring the operation of wireless broadband equipment in accordance with an embodiment of the present invention;

FIG. 3 depicts a computer display of a program that configures a subscriber unit in accordance with an embodiment of the invention;

FIG. 4 depicts illustrates a computer display for a program that configures an access point in accordance with an embodiment of the invention;

FIG. 5 depicts a computer display for a program that configures point-to-point single sector in accordance with an embodiment of the invention;

FIG. 6 depicts a block diagram of a method of arranging configuration data stored in a wireless broadband equipment into a new format in accordance with an embodiment of the present invention;

FIG. 7 depicts a block diagram of a computer display for a program that arranges configuration data stored in a wireless broadband equipment into a new format in accordance with an embodiment of the invention;

FIG. 8 depicts a block diagram of a method of displaying a copy of configuration data stored in a wireless broadband equipment in accordance with an embodiment of the present invention;

FIG. 9 depicts a block diagram of a computer display for a program that displays a copy of configuration data stored in a wireless broadband equipment;

FIG. 10 depicts a block diagram of a method of copying configuration data of a wireless broadband equipment from the computer to the wireless broadband equipment in accordance with an embodiment of the present invention; and

FIG. 11 illustrates a block diagram of a method of programming a wireless broadband equipment in accordance with an embodiment of the present invention.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. For example, in addition to fixed wireless broadband technology, the present invention may be applicable to other forms of communications, such as cellular technology, communications via satellite, or any form of communications not yet known to man as of the date of the present invention. The specific embodiments discussed herein are merely illustrative of specific ways to make and use the invention and do not limit the scope of the invention.

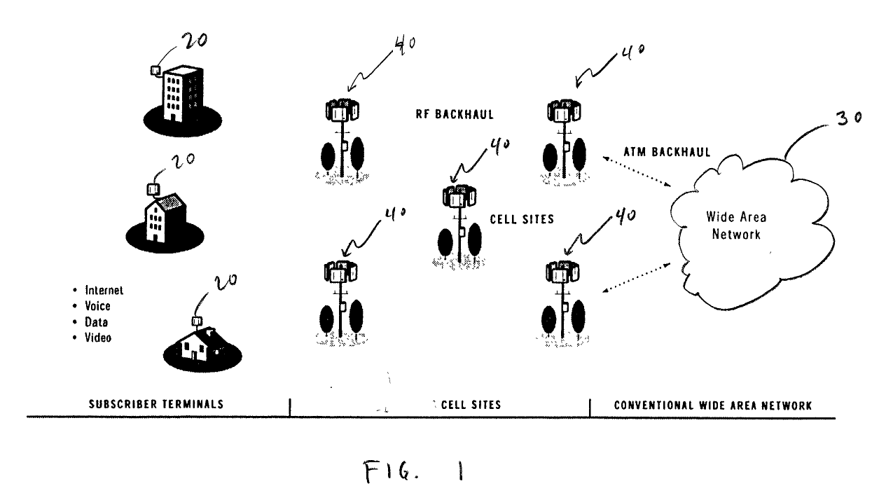

Referring now to FIG. 1, a diagram illustrative of a prior art fixed wireless broadband network 10 is shown. Generally, the fixed wireless broadband network 10 includes a number of cell sites. Each cell site enables communication between a number of subscriber units 20 and the wide area network 30. A cell site typically includes an access point transceiver 40 per sector and an ATM switch (not shown) to interconnect the access points 40 and the wide area network 30. The cell site may also include router configurations (not shown) at the base of the cell site that connects that cell site to other cell cites or the Internet.

Each subscriber unit 20 provides the subscriber, business or residential, with a standard IP over Ethernet or ATM connection, for a single PC or a network of PCs via a hub. Each subscriber unit typically consists of an antenna, which may be a rooftop antenna, to communicate with the cell site, a radio transceiver, and an internal wall junction box with RJ45 socket to provide an Ethernet connection, connected to the transceiver via an external data cable. The antenna is directed towards the most appropriate access point 40, positioned to the correct orientation using adjustable brackets. The subscriber unit antenna is software configurable between vertical and horizontal polarizations, to match the configuration of the appropriate access point.

The set of access points 40 is typically located on the top of a tower or building and is configured in a sectored manner to provide full 360° coverage or appropriate to deployment specifications. Each access point 40 typically uses point-to-multipoint directional antennas. Each access point 40 communicates with the group of service subscribers in the direction it points, supporting many subscribers at any one time. Access point antennas are deployed in horizontal and vertical polarizations, to which the subscriber unit antennas are matched. The access points 40 and the subscriber units 20 may be configured either dynamically or statically. An embodiment of the present invention is directed to statically programming/configuring the units.

In addition to programming access points 40 and subscriber units 20, the present invention may also statically program other wireless broadband equipment, such as switches and routers.

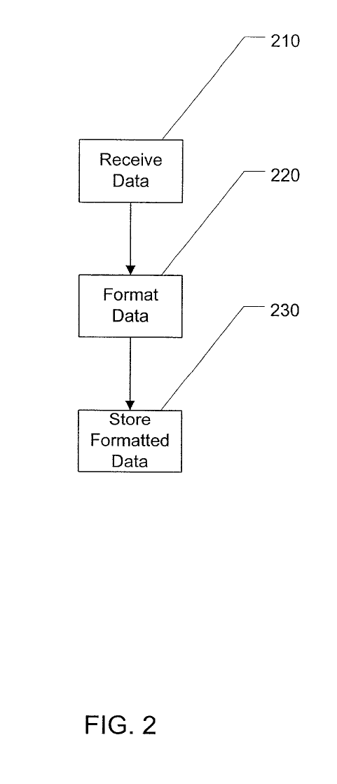

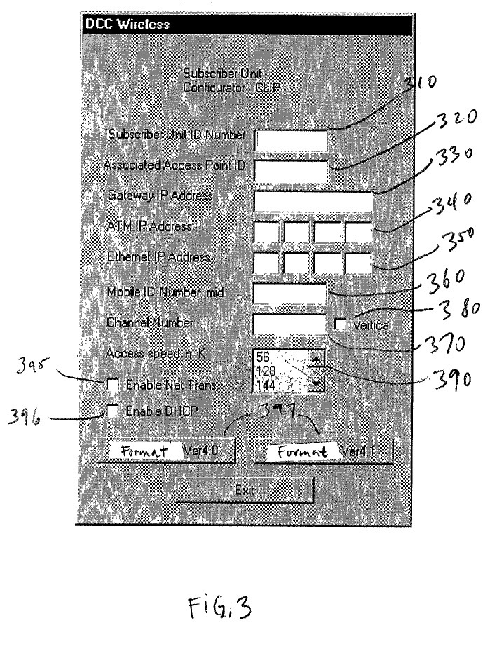

Referring now to FIG. 2, a block diagram illustrative of a method of formatting data for configuring the operation of wireless broadband equipment in accordance with an embodiment of the present invention is shown. The first block 210 of the method is to receive the configuration data. That is, when a technician is ready to configure a network equipment, such as a subscriber unit, he would enter the configuration data necessary to operate that subscriber unit into the program. A computer display for such a program that configures a subscriber unit in accordance with an embodiment of the invention is shown in FIG. 3. The program would be used every time a customer is added to the network.

In accordance with an embodiment of the present invention, the configuration data is grouped into several categories. Subscriber Unit ID Number 310 is a unique identifier that is associated with a particular subscriber unit. This number will be attached to one or more text files that contain the configuration data for that subscriber unit. This number may be any alphanumeric combination. Associated Access Point ID 320 is another unique identifier that the technician may assign to the access point associated with the particular subscriber unit. Gateway IP Address 330 is an Internet protocol address that points to the next hop of the destination. For example, the gateway IP address for a subscriber unit is its associated access point, while the gateway IP address for an access point is its associated backhaul router. ATM IP Address 340 is the Internet protocol address that points to the unit's associated external unit. For a subscriber unit, the ATM IP address is its external IP address that communicates with its associated access point. For an access point, the ATM IP address is the external interface that communicates with its associated subscriber unit. Ethernet IP Address 350 is the internal IP address for the unit. For a subscriber unit, the Ethernet IP address is the internal IP address that communicates with the subscriber's personal computers, for example. For an access point, the Ethernet IP address is its internal IP address that communicates with the router or the switch. Mobile ID Number 360 is a unique number that is permanently assigned to a particular subscriber unit. The mobile ID number may be any number within the range of 1 to 255. Each access point uses this number to identify the particular subscriber unit that is associated with it. Thus, each subscriber unit that is associated with one access point is assigned a number from 1 to 255. Channel Number 370 illustrates the particular channel that is used by the unit. The vertical 380 category signifies the polarization of the antennae of the unit. Access Speed 390 signifies the bandwidth the subscriber has requested. Enable Nat Trans. 395 signifies whether the subscriber has requested network address translation. For example, this category would be checked when the subscriber has only one IP registered in a unit but has more than one personal computer that need Internet connection. Enable DHCP 396 is checked if the subscriber wants to assign one or more IP's to the hosts on the network. Additional categories, such as router information, may further be included in the program. When the technician has completed entering all the configuration data into the program, he would then select on one of the “Format” button 397.

Once the “Format” button 397 is selected, the program then takes all the configuration data and arranges them into a format that is readable by the respective wireless broadband units or equipment, as in block 220. In one embodiment, the format is a standard UNIX format. According to an embodiment of the present invention, the program formats the configuration data according to the particular category of the configuration data. According to another embodiment of the invention, the program determines whether to delete erroneous command lines or to add correct command lines. The program may further delete unnecessary carriage returns and add the number of necessary line feeds.

Once the configuration data is formatted, the program stores the configuration data as a text file in the computer, as shown in block 230. In storing the text file, the program also appends the one or more unique identifier, which were earlier entered by the technician, to the respective wireless broadband equipment. The identifier received in the Subscriber Unit ID Number category 310 will be appended to the text files for the subscriber unit, and the identifier received in the Associated Access Point ID category 320 will be appended to the text files for the associated access point. The number of text files stored in the computer is determined by the configuration data entered into the program. Accordingly, the program stores the appropriate number of text files necessary to configure the wireless broadband equipment. Each wireless broadband equipment therefore has its own set of text files. Two text files, however, will be stored for each wireless broadband equipment. They are the RESOLVE and SYSTEM COMP files. The RESOLVE file is the actual configuration IP data used for communication once the network is established. The SYSTEM COMP file contains the configuration data for the Channel Number and the Mobile ID Number. Further, one text file is invariably stored for formatting the associated access point. If the Enable DHCP category 396 is selected, however, the program will store a DHCPC.CONF file. In accordance with an embodiment of the present invention, these text files are transferable via email. In this manner, these text files are transferable to a technician at a remotely located wireless broadband equipment site. Thus, the technician can retrieve and use the formatted data to program the wireless broadband equipment. Moreover, the program may store the configuration data as an ODBC sequel server file or flat file.

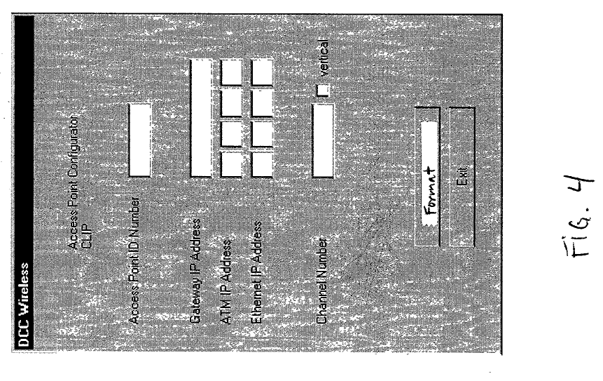

FIG. 4 illustrates a computer display for a program that configures an access point in accordance with an embodiment of the invention. The categories shown in FIG. 4 contain the same description as the ones above. The program as illustrated in FIG. 4 is typically used when a new cell site is built. In accordance with an embodiment of the present invention, when the program configures an access point, the program stores three copies of text files—RESOLVE, SYSTEM COMP, and INET SWITCH.

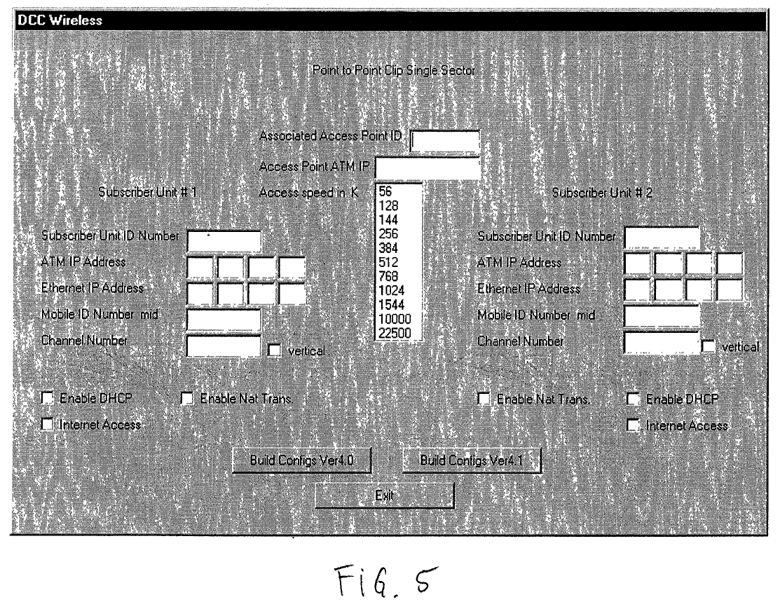

FIG. 5 illustrates a computer display for a program that configures point to point single sector in accordance with an embodiment of the invention. The program illustrated in FIG. 5 is typically used in a situation in which the subscriber wants to have a private point to point network. The subscriber units may be at different cell sites. In this configuration, the program stores an additional text file, i.e., SWITCH INI, which contains information necessary to build an ATM PVC (private virtual connection) from one subscriber unit to another subscriber unit.

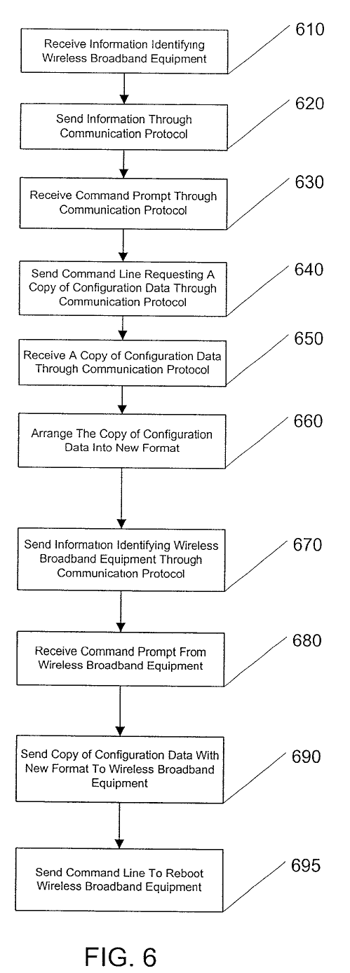

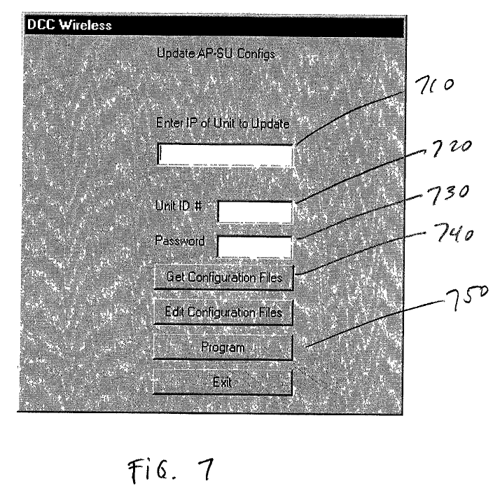

Referring now to FIG. 6, a block diagram illustrative of a method of arranging configuration data stored in a wireless broadband equipment into a new format in accordance with an embodiment of the present invention is shown. This method may be used to facilitate the process of replacing a defective wireless broadband equipment with a new one. The first step of this method is to receive information identifying a particular wireless broadband equipment, as shown in block 610. FIG. 7 illustrates a computer display for a program that arranges configuration data stored in a wireless broadband equipment into a new format in accordance with an embodiment of the invention. The information identifying the particular wireless broadband equipment includes Enter IP of Unit to Update 710, Unit ID # 720 and Password 730. Enter IP of Unit to Update 710 is a category for the IP address of the wireless broadband equipment on its Internet side. This piece of information is used to facilitate the program to communicate with the wireless broadband equipment. Unit ID # 720 is a category for the unique identifier that is associated with a particular wireless broadband equipment. The Password category 730 can be any alphanumeric password that is associated with that particular wireless broadband equipment.

When the Get Configuration Files button 740 is selected, the program sends the information received to the wireless broadband equipment having the IP address that was received in the Enter IP of Unit to Update 710, as shown in block 620. In accordance with an embodiment of the present invention, the program sends the information through a communication protocol, such as Telnet. Telnet is a non-GUI command line interface program that allows communication between network equipments. In accordance with an embodiment of the present invention, Telnet is used as the communication protocol between the program and wireless broadband equipment. Telnet is generally used to input command line data into the units. Other communication protocols, such as SNMP, TFTP and FTP, would also be compatible with the present invention.

Upon successful connection with the wireless broadband equipment, the program will receive a command prompt from the wireless broadband equipment, as shown in block 630. This receipt of the command prompt further indicates that the wireless broadband equipment has accepted the information sent by the program.

Upon receipt of the command prompt from the wireless broadband equipment, the program then sends a command line to the wireless broadband equipment requesting a copy of the configuration data from the wireless broadband equipment, as shown in block 640. The configuration data, in accordance with an embodiment of the present invention, is stored as one or more text files. The wireless broadband equipment then sends a copy of the configuration data to the program, as in block 650.

Upon receipt of the copy of the configuration data, in accordance with an embodiment of the present invention, the program disconnects Telnet and stores the configuration data into a temporary text file. Subsequently, the program arranges the copy of the configuration data into a new format, i.e., a format that is readable by the wireless broadband equipment and meets the subscriber's requirements, as shown in block 660. In arranging the configuration data, the program may remove the old format of the configuration data. In removing the old format from the configuration data, the program may delete one or more erroneous command lines, unnecessary carriage returns, and unnecessary line feeds. In arranging the configuration data into a new format, the program may also add new command lines and line feeds in accordance with subscriber requirement.

In accordance with an embodiment of the present invention, once the configuration data has been arranged into the new format, the program adds the unique identifier, which was received earlier under the Unit ID # category 720, to the text file and stores the text file in the computer. Upon storing the text file in the computer, the program overrides any other text file stored in the computer having the same identifier.

In accordance with another embodiment of the present invention, the program stores the newly formatted configuration data into the wireless broadband equipment. In storing the data, the program must first establish connection with the wireless broadband equipment. In establishing the connection, the program sends the information received under the Enter IP of Unit to Update 710 and Password 730 to the wireless broadband equipment, as shown in block 670. In accordance with an embodiment of the present invention, however, the program sends the information through Rupee, another communication protocol. Rupee is a modified version of TFTP. Rupee is generally used to transfer files to the network equipments. Other communication protocols, such as SNMP, TFTP and FTP, would also be compatible with the present invention. Upon successful connection with the wireless broadband equipment, the program will receive a command prompt from the wireless broadband equipment, as shown in block 680. Upon receipt of the command prompt from the wireless broadband equipment, the program then sends the newly formatted configuration data to the wireless broadband equipment through Rupee, as shown in block 690. The program also sends a command line to the wireless broadband equipment to reboot the wireless broadband equipment, as shown in block 695. Once the wireless broadband equipment reboots, the newly formatted configuration data is permanently stored in the wireless broadband equipment.

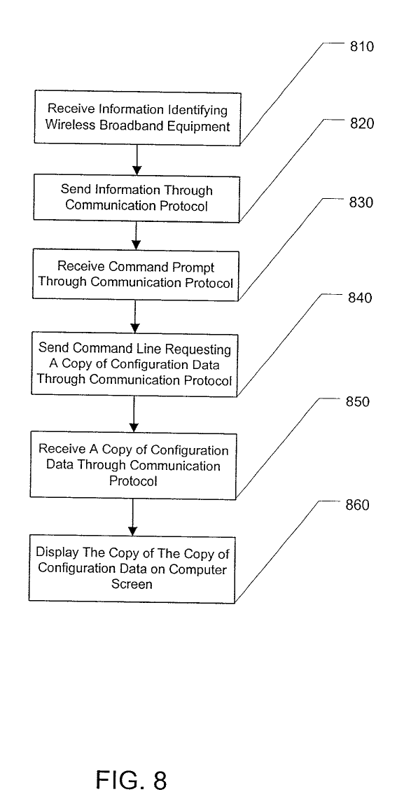

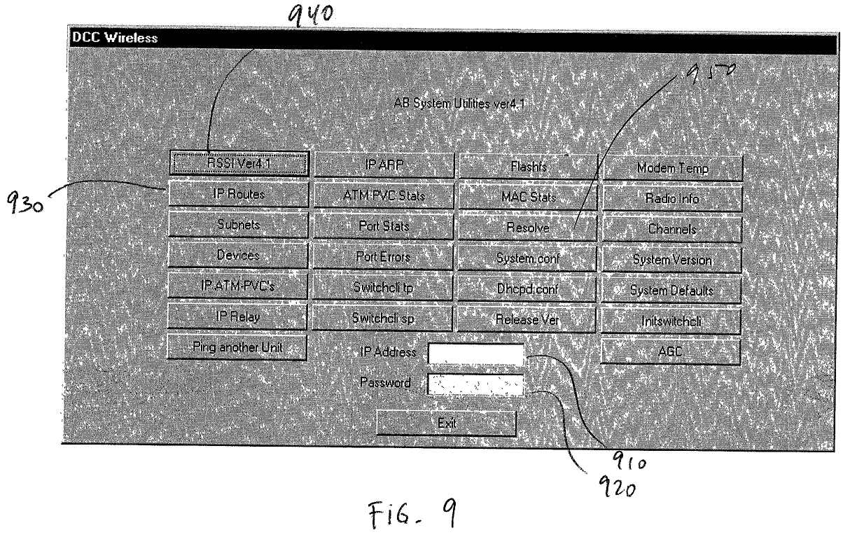

Referring now to FIG. 8, a block diagram illustrative of a method of displaying a copy of configuration data stored in a wireless broadband equipment in accordance with an embodiment of the present invention is shown. The first step of this method is to receive information identifying the particular wireless broadband equipment whose data is to be displayed, as shown in block 810. FIG. 9 illustrates a computer display for a program that displays a copy of configuration data stored in a wireless broadband equipment. In one embodiment, the information includes the IP Address category 910 and the Password 920. As explained above, the IP Address category 910 is a category for the IP address of the wireless broadband equipment on its Internet side. This piece of information is use to facilitate the program to communicate with the wireless broadband equipment. The Password category 920 can be any alphanumeric password that is associated with that particular wireless broadband equipment.

When one of the predefined command buttons, as in IP Routes 930, is selected, the program sends that information to the wireless broadband equipment having the IP address that was received in the IP Address category 910, as shown in block 820. In accordance with an embodiment of the present invention, the program sends the information through a communication protocol, such as Telnet. Telnet is a non-GUI command line interface program that allows communication between network equipments. In accordance with an embodiment of the present invention, Telnet is used as the communication protocol between the program and wireless broadband equipment. Telnet is generally used to input command line data into the units. Other communication protocols, such as SNMP, TFTP and FTP, would also be compatible with the present invention.

Upon successful connection with the wireless broadband equipment, the program will receive a command prompt from the wireless broadband equipment, as shown in block 830. This receipt of the command prompt indicates that the wireless broadband equipment has accepted the information sent by the program.

Upon receipt of the command prompt from the wireless broadband equipment, the program then sends a command line to the wireless broadband equipment requesting a copy of the configuration data from the wireless broadband equipment, as shown in block 840. In accordance with an embodiment of the present invention, the program offers twenty-three different predefined command buttons. The present invention, however, is not necessarily limited by the number of predefined command buttons. Each predefined command button contains a command line requesting various portions of the configuration data. For example, the RSSI Ver 4.1 command button 940 refers to a set of data pertaining to the RECEIVED SIGNAL STRENGTH INDICATION. IP Routes command button 930 refers to all Internet protocol routes known by the wireless broadband equipment. Resolve command button 950 refers to all the configuration data of the wireless broadband equipment. Therefore, each predefined command button contains a different command line that requests a different portion of the configuration data. In response to one of the predefined command button, the wireless broadband equipment sends a copy of the configuration data requested to the program, as in block 850.

Once the particular set of configuration data is received, the program displays the data on the computer screen, as shown in block 860. The data may be displayed in its ASCII format. This ability to display the configuration data stored in a wireless broadband equipment allows a technician to easily diagnose a particular wireless broadband equipment.

In accordance with an embodiment of the present invention, the program may further store the configuration data into a temporary text file for later diagnostic. Yet in accordance with another embodiment of the present invention, the program allows one to manually edit the configuration data displayed on the screen.

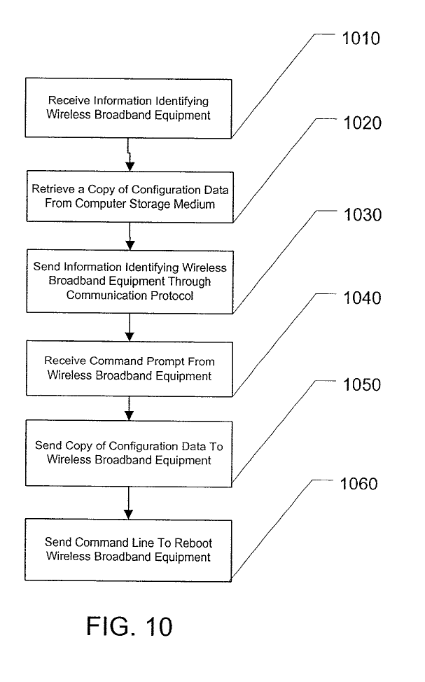

Referring now to FIG. 10, a block diagram illustrative of a method of copying configuration data of a wireless broadband equipment from the computer to the wireless broadband equipment in accordance with an embodiment of the present invention is shown. The first step of this program is to receive information identifying a particular wireless broadband equipment, as shown in block 1010. As shown in FIG. 7, the information identifying the particular wireless broadband equipment includes Enter IP of Unit to Update 710, Unit ID # 720 and Password 730. When the Program command button 750 (FIG. 7) is selected, the program retrieves a copy of the configuration data that is associated with the unique identifier entered in the Unit ID # 720 category, as shown in block 1020. In one embodiment of the present invention, the configuration data is stored as text files. The program, therefore, retrieves all the text files associated with the unique identifier.

In preparation of sending the retrieved data to the wireless broadband equipment, the program may remove any identifier that may be appended to the text files. Then, the program sends the information received under the Enter IP of Unit to Update 710 and Password 730 to the wireless broadband equipment, as shown in block 1030. In accordance with an embodiment of the present invention, the program sends the information through Rupee. Upon successful connection with the wireless broadband equipment, the program will receive a command prompt from the wireless broadband equipment, as shown in block 1040. Upon receipt of the command prompt from the wireless broadband equipment, the program will send the retrieved copy of the configuration data to the wireless broadband equipment through Rupee, as shown in block 1050. The program also sends a command line to the wireless broadband equipment to reboot the wireless broadband equipment, as shown in block 1060. Once the wireless broadband equipment reboots, the retrieved copy of the configuration data is permanently stored in the wireless broadband equipment.

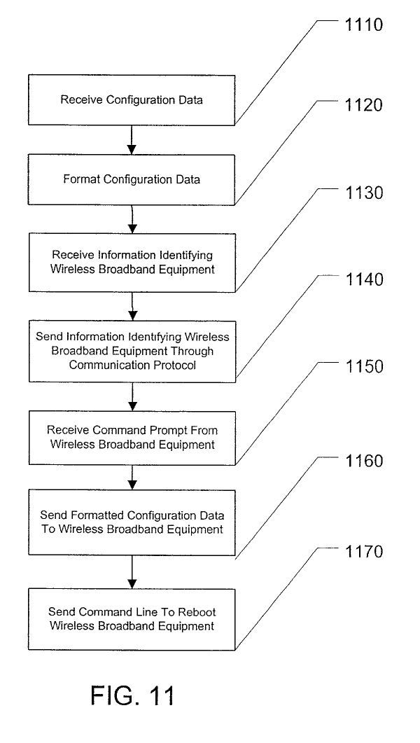

Referring now to FIG. 11, a block diagram illustrative of a method of programming a wireless broadband equipment in accordance with an embodiment of the present invention is shown. The first step 1110 of the method is to receive the configuration data. The first block 210 of the method is to receive the configuration data. That is, when a technician is ready to program the wireless broadband equipment, he would enter into the program the configuration data necessary to operate that wireless broadband equipment. Once all the configuration data is received, the program arranges them into a format that is readable by the respective wireless broadband equipment, as in block 1120. According to an embodiment of the invention, the program determines whether to delete erroneous command lines or to add correct command lines. The program may further delete unnecessary carriage returns and add the number of necessary line feeds. Once the configuration data has been formatted, the program stores the formatted configuration data into the wireless broadband equipment. In storing the data, the program must first establish connection with the wireless broadband equipment. In establishing the connection, the program receives information about the wireless broadband equipment, as shown in block 1130. Then, the program sends the information to the wireless broadband equipment, as shown in block 1140. In accordance with an embodiment of the present invention, the program sends the information through Rupee. Upon successful connection with the wireless broadband equipment, the program will receive a command prompt from the wireless broadband equipment, as shown in block 1150. Upon receipt of the command prompt from the wireless broadband equipment, the program will send the formatted configuration data to the wireless broadband equipment through Rupee, as shown in block 1160. The program also sends a command line to the wireless broadband equipment to reboot the wireless broadband equipment, as shown in block 1170. Once the wireless broadband equipment reboots, the formatted configuration data is permanently stored in the wireless broadband equipment.

In accordance with an embodiment of the present invention, the entire program is compiled in one executive program. This program is compatible with all versions of 32 bit Windows, e.g., Windows '95, '98, NT, and 2000. The program can also be written in C++, Visual Basics, Pearl, any Windows interface language.

The programming may be accomplished through the use of a program storage device readable by the computer and encoding a program of instructions executable by the computer for performing the operations described above. The program storage device may take the form of, e.g., one or more floppy disks; a CD ROM or other optical disk; a magnetic tape; a read-only memory chip (ROM); and other forms of the kind well-known in the art or subsequently developed. The program of instructions may be “object code,” i.e., in binary form that is executable more-or-less directly by the computer; in “source code” that requires compilation or interpretation before execution; or in some intermediate form such as partially compiled code. The precise forms of the program storage device and of the encoding of instructions are immaterial here.

The embodiments and examples set forth herein are presented to best explain the present invention and its practical application and to thereby enable those skilled in the art to make and utilize the invention. However, those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims.

What is claimed is:

1. A method of formatting data for programming the operation of one or more wireless broadband equipment, the method comprising the steps of:
receiving the data;
arranging the data into a format readable by the one or more wireless broadband equipment; and
storing the arranged data into one or more text files.

2. The method of claim 1, wherein the step of arranging the data comprises the step of adding one or more command lines to the data.

3. The method of claim 1, wherein the step of arranging the data comprises the step of adding one or more line feeds.

4. The method of claim 1, further comprising the step of grouping the data into one or more categories.

5. The method of claim 4, wherein the step of arranging the data comprises the step of arranging the data according to the one or more categories.

6. The method of claim 4, wherein the step of arranging the data comprises the step of adding one or more command lines according to the one or more categories.

7. The method of claim 1, wherein the step of storing the data into one or more text files includes the step of appending one or more identifiers to the one or more text files, the one or more identifiers associating the one or more text files with the one or more wireless broadband equipment.

8. The method of claim 1, wherein the step of storing the data into one or more text files includes the step of determining the number of text files according to the data received.

9. The method of claim 1, wherein the step of storing the data into one or more text files comprises the step of storing the data into one or more RESOLVE files.

10. The method of claim 1, wherein the step of storing the data into one or more text files comprises the step of storing the data into one or more SYSTEM COMP files.

11. The method of claim 1, wherein the step of storing the data into one or more text files comprises the step of storing the data into one or more SWITCH INI files when the data includes at least two subscriber unit identification numbers and at least one access point identification number associated with the at least two subscriber unit identification numbers.

12. The method of claim 1, wherein the one or more wireless broadband equipment comprise one or more access points.

13. The method of claim 1, wherein the one or more wireless broadband equipment comprise one or more subscriber units.

14. The method of claim 1, wherein the one or more wireless broadband equipment comprise one or more network routers.

15. The method of claim 1, wherein the one or more wireless broadband equipment comprise one or more network switches.

16. The method of claim 1, wherein the data comprise one or more gateway Internet protocol addresses for the one or more wireless broadband equipment.

17. The method of claim 1, wherein the data comprise one or more ATM Internet protocol addresses for the one or more wireless broadband equipment.

18. The method of claim 1, wherein the data comprise one or more Ethernet Internet protocol addresses for the one or more wireless broadband equipment.

19. The method of claim 1, wherein the data comprises the frequency used by the one or more wireless broadband equipment.

20. The method of claim 1, wherein the data comprises the bandwidth used by the one or more wireless equipment.

21. A method of arranging configuration data stored in a wireless broadband equipment into a new format, the method comprising the steps of:
retrieving a copy of the configuration data from the wireless broadband equipment;
arranging the copy of the configuration data into the new format; and
storing the copy of the configuration data with the new format into the wireless broadband equipment.

22. The method of claim 21, wherein the step of retrieving a copy of the configuration data comprises the steps of:
establishing a first electrical connection with the wireless broadband equipment;
sending a command line to the wireless broadband equipment through the first electrical connection, the command line requesting a copy of the configuration data from the wireless broadband equipment; and
receiving the copy of the configuration data from the wireless broadband equipment through the first electrical connection.

23. The method of claim 21, wherein the step of arranging the copy of the configuration data comprises the steps of:
removing the old format from the copy of the configuration data; and
arranging the copy of the configuration data into the new format.

24. The method of claim 23, wherein the step of removing the old format comprises the step of deleting one or more command lines from the copy of the configuration data.

25. The method of claim 23, wherein the step of removing the old format comprises the step of deleting one or more carriage returns.

26. The method of claim 21, wherein the step of arranging the copy of the configuration data comprises the step of adding one or more command lines.

27. The method of claim 21, wherein the step of arranging the copy of the configuration data comprises the step of adding one or more line feeds.

28. The method of claim 22, wherein the step of establishing a first electrical connection with the wireless broadband equipment comprises the steps of:
receiving a first set of information identifying the wireless broadband equipment;
sending the information to the wireless broadband equipment through the first electrical connection; and
receiving a first command prompt from the wireless broadband equipment through the first electrical connection, the first command prompt indicating that the information has been accepted by the wireless broadband equipment.

29. The method of claim 28, wherein the first set of information includes the Internet protocol address for the wireless broadband equipment; and wherein the first set of information is sent to the wireless broadband equipment having the Internet protocol address.

30. The method of claim 22, wherein the first electrical connection is a communication protocol.

31. The method of claim 30, wherein the communication protocol is Telnet.

32. The method of claim 21, wherein the step of storing the copy of the configuration data comprises the steps of:
establishing a second electrical connection with the wireless broadband equipment; and
sending the copy of the configuration data with the new format to the wireless broadband equipment through the second electrical connection.

33. The method of claim 32, wherein the step of storing the copy of the configuration data further comprises the step of:
sending a rebooting command line to the wireless broadband equipment through the second electrical connection, the rebooting command line permanently storing the copy of the configuration data to the wireless broadband equipment.

34. The method of claim 32, wherein the second electrical connection is a communication protocol.

35. The method of claim 34, wherein the communication protocol is Rupee.

36. A method of displaying a copy of configuration data stored in a wireless broadband equipment, the method comprising the steps of:
retrieving the copy of the configuration data stored in the wireless broadband equipment; and
displaying the copy of the configuration data on a computer screen.

37. The method of claim 36, wherein the step of retrieving the copy comprises the steps of:
establishing an electrical connection with the wireless broadband equipment;
sending a command line to the wireless broadband equipment through the electrical connection, the command line requesting the copy of the configuration data from the wireless broadband equipment; and
receiving the copy of the configuration data from the wireless broadband equipment through the electrical connection.

38. The method of claim 37, wherein the command line is a predefined command line requesting a particular set of configuration data.

39. The method of claim 38, wherein the particular set of configuration data is RECEIVED SIGNAL STRENGTH INDICATION.

40. The method of claim 38, wherein the particular set of configuration data is all the Internet protocol routes known by the wireless broadband equipment.

41. The method of claim 38, wherein the particular set of configuration data is all the configuration data of the wireless broadband equipment.

42. The method of claim 36, wherein the step of establishing an electrical connection with the wireless broadband equipment comprises the steps of:
receiving information identifying the wireless broadband equipment;
sending the information to the wireless broadband equipment through the electrical connection; and
receiving a command prompt from the wireless broadband equipment through the electrical connection, the command prompt indicating that the information has been accepted by the wireless broadband equipment.

43. The method of claim 42, wherein the information includes the Internet protocol address for the wireless broadband equipment.

44. The method of claim 37, wherein the electrical connection is a communication protocol.

45. The method of claim 44, wherein the communication protocol is Telnet.

46. A method of copying configuration data of a wireless broadband equipment from a program storage device to the wireless broadband equipment, the method comprising the steps of:
retrieving a copy of the configuration data from the program storage device;
establishing an electrical connection with the wireless broadband equipment;
sending the copy of the configuration data to the wireless broadband equipment through the electrical connection; and
sending a command line to the wireless broadband equipment through the electrical connection, the command line rebooting the wireless broadband equipment.

47. The method of claim 46, wherein the step of retrieving a copy of the configuration data comprises the steps of:
receiving information identifying the wireless broadband equipment, the information having an identifier associated with the wireless broadband equipment; and
retrieving the configuration data associated with the identifier from the program storage device.

48. The method of claim 46, wherein the step of sending the copy of the configuration data to the wireless broadband equipment comprises the step of:
removing the identifier associated with the wireless broadband equipment prior to sending the copy of the configuration data to the wireless broadband equipment.

49. The method of claim 46, wherein the step of establishing an electrical connection to the wireless broadband equipment comprises the steps of:
receiving information identifying the wireless broadband equipment;
sending the information to the wireless broadband equipment through the electrical connection; and
receiving a command prompt from the wireless broadband equipment through the electrical connection, the command prompt indicating that the information has been accepted by the wireless broadband equipment.

50. The method of claim 46, wherein the electrical connection is a communication protocol.

51. The method of claim 46, wherein the communication protocol is Rupee.

52. The method of claim 49, wherein the information includes the Internet protocol address for the wireless broadband equipment.

53. The method of claim 49, wherein the information includes a password required for accessing the wireless broadband equipment.

54. A method of configuring a wireless broadband equipment, the method comprising the steps of:
receiving one or more configuration data;
arranging the one or more configuration data into a format readable by the wireless broadband equipment; and
storing the arranged one or more configuration data into the wireless broadband equipment.

55. The method of claim 54, wherein the step of storing the arranged one or more configuration data comprises the steps of:
establishing an electrical connection with the wireless broadband equipment;
sending the arranged one or more configuration data to the wireless broadband equipment through the electrical connection; and
sending a command line to the wireless broadband equipment through the electrical connection, the command line rebooting the wireless broadband equipment.

56. The method of claim 55, wherein the step of sending the arranged one or more configuration data comprises the step of sending the arranged one or more configuration data in one or more text files.

57. The method of claim 55, wherein the step of sending the arranged one or more configuration data further comprises the step of determining the number of text files according to the one or more configuration data received.

58. The method of claim 55, wherein the step of establishing an electrical connection to the wireless broadband equipment comprises the steps of:
receiving information identifying the wireless broadband equipment;
sending the information to the wireless broadband equipment through the electrical connection; and
receiving a command prompt from the wireless broadband equipment through the electrical connection, the command prompt indicating that the information has been accepted by the wireless broadband equipment.

59. The method of claim 55, wherein the electrical connection is a communication protocol.

60. The method of claim 59, wherein the communication protocol is Rupee.

61. A computer program for formatting data for programming the operation of one or more wireless broadband equipment embodied on a computer readable medium, the computer program comprising:
a code segment for receiving the data;
a code segment for arranging the data into a format readable by the one or more wireless broadband equipment; and
a code segment for storing the arranged data into one or more text files.

62. The computer program of claim 61, wherein the code segment for arranging the data comprises a code segment for adding one or more command lines to the data.

63. The computer program of claim 61, wherein the code segment for arranging the data comprises a code segment for adding one or more line feeds.

64. The computer program of claim 61, further comprising a code segment for grouping the data into one or more categories.

65. The computer program of claim 64, wherein the code segment for arranging the data comprises a code segment for arranging the data according to the one or more categories.

66. The computer program of claim 61, wherein the code segment for storing the data into one or more text files includes a code segment for appending one or more identifiers to the one or more text files, the one or more identifiers associating the one or more text files with the one or more wireless broadband equipment.

67. The computer program of claim 61, wherein the code segment for storing the data into one or more text files includes a code segment for determining the number of text files according to the data received.

68. A computer program for arranging configuration data stored in a wireless broadband equipment into a new format embodied on a computer readable medium, the computer program comprising:
a code segment for retrieving a copy of the configuration data from the wireless broadband equipment;
a code segment for arranging the copy of the configuration data into the new format; and
a code segment for storing the copy of the configuration data with the new format into the wireless broadband equipment.

69. The computer program of claim 68, wherein the code segment for retrieving a copy of the configuration data comprises:
a code segment for establishing a first electrical connection with the wireless broadband equipment;
a code segment for sending a command line to the wireless broadband equipment through the first electrical connection, the command line requesting a copy of the configuration data from the wireless broadband equipment; and
a code segment for receiving the copy of the configuration data from the wireless broadband equipment through the first electrical connection.

70. The computer program of claim 68, wherein the code segment for arranging the copy of the configuration data comprises:
a code segment for removing the old format from the copy of the configuration data; and
a code segment for arranging the copy of the configuration data into the new format.

71. The computer program of claim 70, wherein the code segment for removing the old format comprises a code segment for deleting one or more command lines from the copy of the configuration data.

72. The computer program of claim 70, wherein the code segment for removing the old format comprises the step of deleting one or more carriage returns.

73. The computer program of claim 68, wherein the code segment for arranging the copy of the configuration data comprises a code segment for adding one or more command lines.

74. The computer program of claim 68, wherein the code segment for arranging the copy of the configuration data comprises a code segment for adding one or more line feeds.

75. The computer program of claim 69, wherein the code segment for establishing a first electrical connection with the wireless broadband equipment comprises:
a code segment for receiving information identifying the wireless broadband equipment;
a code segment for sending the information to the wireless broadband equipment through the first electrical connection; and
a code segment for receiving a first command prompt from the wireless broadband equipment through the first electrical connection, the first command prompt indicating that the information has been accepted by the wireless broadband equipment.

76. The computer program of claim 68, wherein the code segment for storing the copy of the configuration data comprises:
a code segment for establishing a second electrical connection with the wireless broadband equipment;
a code segment for sending the copy of the configuration data with the new format to the wireless broadband equipment through the second electrical connection; and
a code segment for sending a command line to the wireless broadband equipment through the second electrical connection, the command line rebooting the wireless broadband equipment.

77. The computer program of claim 75, wherein the code segment for establishing a second electrical connection comprises:
a code segment for sending the information to the wireless broadband equipment through the second electrical connection; and
a code segment for receiving a second command prompt from the wireless broadband equipment through the electrical connection, the second command prompt indicating that the information has been accepted by the wireless broadband equipment.

78. A computer program for displaying a copy of configuration data stored in a wireless broadband equipment embodied on a computer readable medium, the computer program comprising:
a code segment for retrieving the copy of the configuration data stored in the wireless broadband equipment; and
a code segment for displaying the copy of the configuration data on a computer screen.

79. The computer program of claim 78, wherein the code segment for retrieving the copy comprises the steps of:
a code segment for establishing an electrical connection with the wireless broadband equipment;
a code segment for sending a command line to the wireless broadband equipment through the electrical connection, the command line requesting the copy of the configuration data from the wireless broadband equipment; and
a code segment for receiving the copy of the configuration data from the wireless broadband equipment through the electrical connection.

80. The computer program of claim 79, wherein the command line is a predefined command line requesting a particular set of configuration data.

81. The computer program of claim 78, wherein the code segment for establishing an electrical connection with the wireless broadband equipment comprises:
a code segment for receiving information identifying the wireless broadband equipment;
a code segment for sending the information to the wireless broadband equipment through the electrical connection; and
a code segment for receiving a command prompt from the wireless broadband equipment through the electrical connection, the command prompt indicating that the information has been accepted by the wireless broadband equipment.

82. A computer program for copying configuration data of a wireless broadband equipment from a program storage device to the wireless broadband equipment embodied on a computer readable medium, the computer program comprising:
a code segment for retrieving a copy of the configuration data from the program storage device;
a code segment for establishing an electrical connection with the wireless broadband equipment;
a code segment for sending the copy of the configuration data to the wireless broadband equipment through the electrical connection; and
a code segment for sending a command line to the wireless broadband equipment through the electrical connection, the command line rebooting the wireless broadband equipment.

83. The computer program of claim 82, wherein the code segment for establishing an electrical connection to the wireless broadband equipment comprises:
a code segment for receiving information identifying the wireless broadband equipment;
a code segment for sending the information to the wireless broadband equipment through the electrical connection; and
a code segment for receiving a command prompt from the wireless broadband equipment through the electrical connection, the command prompt indicating that the information has been accepted by the wireless broadband equipment.

84. A computer program for configuring a wireless broadband equipment embodied on a computer readable medium, the computer program comprising:
a code segment for receiving one or more configuration data;
a code segment for arranging the one or more configuration data into a format readable by the wireless broadband equipment; and
a code segment for storing the arranged one or more configuration data to the wireless broadband equipment.

85. The computer program of claim 84, wherein the code segment for arranging the one or more configuration data comprises a code segment for adding one or more command lines to the one or more configuration data.

86. The computer program of claim 84, wherein the code segment for arranging the one or more configuration data comprises a code segment for adding one or more line feeds.

87. The computer program of claim 84, wherein further comprising a code segment for grouping the one or more configuration data into one or more categories.

88. The computer program of claim 87, wherein the code segment for arranging the one or more configuration data comprises a code segment for arranging the one or more configuration data according to the one or more categories.

89. The computer program of claim 87, wherein the code segment for arranging the one or more configuration data comprises a code segment for adding one or more command lines according to the one or more categories.

90. The computer program of claim 84, wherein the code segment for storing the arranged one or more configuration data comprises:
a code segment for establishing an electrical connection with the wireless broadband equipment;
a code segment for sending the arranged one or more configuration data to the wireless broadband equipment through the electrical connection; and
a code segment for sending a command line to the wireless broadband equipment through the electrical connection, the command line rebooting the wireless broadband equipment.

91. The computer program of claim 90, wherein the code segment for sending the arranged one or more configuration data comprises a code segment for sending the arranged one or more configuration data in one or more text files.

92. The computer program of claim 90, wherein the code segment for sending the arranged one or more configuration data further comprises a code segment for determining the number of text files according to the one or more configuration data received.

93. The computer program of claim 90, wherein the code segment for establishing an electrical connection to the wireless broadband equipment comprises:
a code segment for receiving information identifying the wireless broadband equipment;
a code segment for sending the information to the wireless broadband equipment through the electrical connection; and
a code segment for receiving a command prompt from the wireless broadband equipment through the electrical connection, the command prompt indicating that the information has been accepted by the wireless broadband equipment.
